(19) United States
(12) Patent Application Publication
(10) Pub. No.: US 2023/0162714 A1
(43) Pub. Date: May 25, 2023

(54) MUSICAL PIECE GENERATION DEVICE, MUSICAL PIECE GENERATION METHOD, MUSICAL PIECE GENERATION PROGRAM, MODEL GENERATION DEVICE, MODEL GENERATION METHOD, AND MODEL GENERATION PROGRAM

(71) Applicant: Yamaha Corporation, Hamamatsu (JP)

(72) Inventor: Masahiro SUZUKI, Hamamatsu (JP)

(21) Appl. No.: 17/991,819

(22) Filed: Nov. 21, 2022

(30) Foreign Application Priority Data
Nov. 24, 2021 (JP) 2021-190312

(51) Int. Cl. G10H 5/02

(52) U.S. Cl. CPC G10H 5/02; G10H 2210/161; G10H 2250/311

(57) ABSTRACT

A musical piece generation device includes an electronic controller including at least one processor. The electronic controller is configured to execute a plurality of modules including a data acquisition module configured to acquire target musical piece data indicating at least a part of a musical piece, a parameter acquisition module configured to acquire a value of a difficulty level parameter, a generation module configured to, by using a trained generative model, generate, from the target musical piece data and the value of the difficulty level parameter, new musical piece data indicating at least a part of a new musical piece obtained by changing a difficulty level of the musical piece to a difficulty level specified by the difficulty level parameter, and an output module configured to output the new musical piece data that has been generated.

### CROSS-REFERENCE TO RELATED APPLICATIONS

This application claims priority to Japanese Patent Application No. 2021-190312, filed on Nov. 24, 2021. The entire disclosure of Japanese Patent Application No. 2021-190312 is hereby incorporated herein by reference.

### BACKGROUND

### Technical Field

This disclosure relates to a musical piece generation device, a musical piece generation method, a musical piece generation program, a model generation device, a model generation method, and a model generation program.

### Background Information

Conventionally, changing a difficulty level of a musical piece has primarily been performed manually by a person. However, if the entire process of changing the difficulty level of the musical piece and generating a new musical piece is performed manually, the costs associated therewith will be high. Thus, methods for using computer technology to automate at least part of the work with respect to the musical piece are being developed.

For example, Japanese Laid-Open Patent Application No. 2007-241026 proposes a technology for a rule-based automatic generation of abridged musical score information. By this method, at least part of the work for changing the difficulty level can be automated. Therefore, it is possible to reduce the cost of the work required to change the difficulty level.

### SUMMARY

The inventor found that the above-described conventional method of changing the difficulty level has the following problem. That is, it was found that when it was attempted to generate a new musical piece in which the difficulty level has been changed by a rule-based system, a very uniform arrangement tends to result. For example, in the conventional method, an arranged musical piece is generated by simple rules that omit sounds. However, such a method tends to produce monotonous arrangements, resulting in an arranged musical piece of low quality. For example, the appropriate difficulty level of a musical piece can vary from performer to performer (for example, certain operators may be difficult to operate depending on the size of the performer's hands, etc.). With the conventional method, it is difficult to respond to diverse designations of the difficulty level; thus, it is difficult to use the method in commercial applications, such as the automatic generation of arranged musical pieces and the production of corresponding musical scores.

This disclosure is conceived in light of the foregoing circumstances, and an object thereof is to provide a technology that can easily generate musical pieces with various difficulty levels.

In order to solve the above-mentioned problem, this disclosure employs the following configuration.

That is, a musical piece generation device according to one aspect of this disclosure comprises an electronic controller including at least one processor. The electronic controller is configured to execute a plurality of modules including a data acquisition module configured to acquire target musical piece data indicating at least a part of a musical piece, a parameter acquisition module configured to acquire a value of a difficulty level parameter, a generation module configured to, by using a trained generative model, generate, from the target musical piece data and the value of the difficulty level parameter, new musical piece data indicating at least a part of a new musical piece obtained by changing a difficulty level of the musical piece to a difficulty level specified by the difficulty level parameter, and an output module configured to output the new musical piece data that has been generated.

A musical piece generation method according to another aspect of this disclosure is executed by a computer, and comprises acquiring target musical piece data indicating at least a part of a musical piece, acquiring a value of a difficulty level parameter, generating, by using a trained generative model, from the target musical piece data and the value of difficulty level parameter, new musical piece data indicating at least a part of a new musical piece obtained by changing a difficulty level of the musical piece to a difficulty level specified by the difficulty level parameter, and outputting the new musical piece data that has been generated.

A model generation method according to another aspect of this disclosure is executed by a computer, and comprises acquiring a plurality of training datasets each of which includes a combination of training data and correct answer data, and executing machine learning of a generative model by using the plurality of training datasets that have been acquired. The training data include training musical piece data that indicate at least a part of a musical piece and include a difficulty level parameter for training, and the correct answer data include new training musical piece data indicating at least a part of a new musical piece generated by changing a difficulty level of the musical piece of the training musical piece data to a difficulty level specified by the difficulty level parameter. The machine learning is configured by training the generative model such that, with respect to each of the training datasets, musical piece data, which are generated by the generative model from the training musical piece data and a value of the difficulty level parameter that are included in the training data, match the new training musical piece data included in the correct answer data.

### BRIEF DESCRIPTION OF THE DRAWINGS

FIG. 1 schematically illustrates one example of a scenario in which this disclosure is applied.

FIG. 2 schematically illustrates one example of the hardware configuration of the model generation device according to an embodiment.

FIG. 3 schematically illustrates one example of the hardware configuration of the musical piece generation device according to an embodiment.

FIG. 4 schematically illustrates one example of the hardware configuration of the model generation device according to an embodiment.

FIG. 5 is a musical score showing one example of a musical piece.

FIG. 6A shows one example of an input token sequence generated from the musical piece of FIG. 5.

FIG. 6B shows one example of the input token sequence generated from the musical piece of FIG. 5.

FIG. 7 is a musical score showing one example of a musical piece (generation result) in which the difficulty level has been changed.

FIG. 8A shows one example of the true value of an output token sequence corresponding to the musical piece of FIG. 7.

FIG. 8B shows one example of a true value of the output token sequence corresponding to the musical piece of FIG. 7.

FIG. 9 schematically illustrates one example of the configuration of a generative model according to the embodiment.

FIG. 10 schematically illustrates one example of the software configuration of a musical piece generation device according to an embodiment.

FIG. 11 is a flowchart showing one example of the processing procedure of the model generation device according to the embodiment.

FIG. 12 is a flowchart showing one example of the processing procedure of the musical piece generation device according to the embodiment.

### DETAILED DESCRIPTION OF THE EMBODIMENTS

An embodiment according to one aspect of this disclosure (hereinafter also referred to as the “present embodiment”) will be described below with reference to the drawings. However, the present embodiment described below is merely an example of this disclosure in all respects. Various improvements and modifications can of course be made without departing from the scope of this disclosure. That is, when this disclosure is implemented, specific configurations that correspond to the embodiment can be appropriately employed. Although the data that appear in the present embodiment are described using natural language, the data can be specified more specifically in pseudo language, commands, parameters, machine language, etc., that can be recognized by a computer.

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### § 1 Application Example

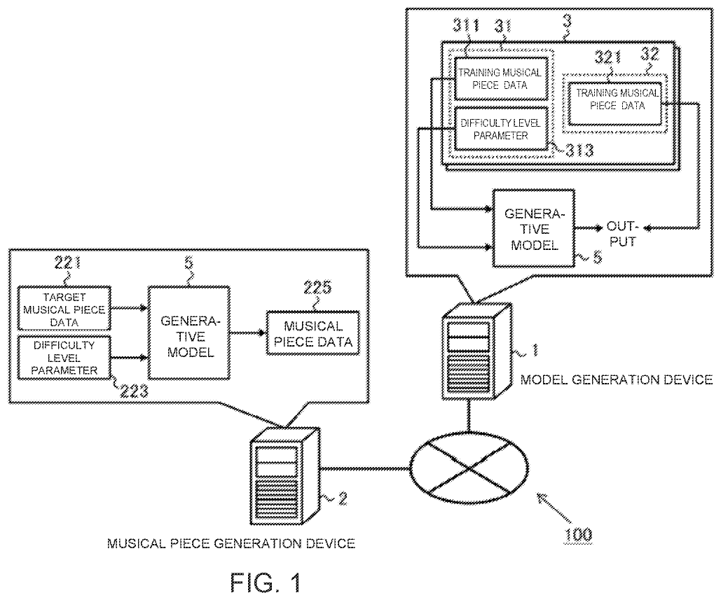

FIG. 1 schematically illustrates one example of a scenario in which this disclosure is applied. As shown in FIG. 1, a generation system 100 according to the present embodiment comprises a model generation device 1 and a musical piece generation device 2.

The model generation device 1 according to the present embodiment is a computer configured to generate, by machine learning, a trained generative model 5 for generating a new musical piece in which the difficulty level of the original musical piece has been changed. First, the model generation device 1 acquires a plurality of training datasets 3. Each of the training datasets 3 includes a combination of training data 31 and correct answer data 32. The training data 31 are configured to include training musical piece data 311 indicating at least a part of a musical piece and a difficulty level parameter 313 for training. The correct answer data 32 are configured to include new training musical piece data 321 indicating at least a part of a new musical piece generated by changing the difficulty level of the musical piece of the training musical piece data 311 to the difficulty level specified by the difficulty level parameter 313.

The model generation device 1 then uses the acquired plurality of training datasets 3 to execute the machine learning of the generative model 5. The machine learning is configured by training the generative model 5 such that, with respect to each of the training datasets 3, musical piece data generated by the generative model 5 from the training musical piece data 311 and a value of the difficulty level parameter 313 included in the training data 31 match the new training musical piece data 321 included in the correct answer data 32. This machine learning process can produce a trained generative model 5 that has acquired the ability to generate, from the original musical piece, a new musical piece with a difficulty level specified by the difficulty level parameter 313.

On the other hand, the musical piece generation device 2 according to the present embodiment is a computer configured to use the trained generative model 5 to generate a new musical piece from an original musical piece. First, the musical piece generation device 2 acquires target musical piece data 221 indicating at least a part of a musical piece. Further, the musical piece generation device 2 acquires a value of a difficulty level parameter 223 for specifying the difficulty level of the musical piece following the change. The musical piece generation device 2 then uses the trained generative model 5 to generate, from the acquired target musical piece data 221 and the value of the difficulty level parameter 223, new musical piece data 225 indicating at least a part of a new musical piece obtained by changing the difficulty level of the musical piece to the difficulty level specified by the difficulty level parameter 223. The musical piece generation device 2 outputs the generated new musical piece data 225.

The difficulty level parameters (223, 313) are configured to indicate the difficulty level of the new musical piece generated from the original musical piece by the generative model 5. The difficulty level parameter 313 in the training stage is configured to indicate the difficulty level of the musical piece indicated by the training musical piece data 321 constituting the correct answer data 32 with respect to the training musical piece data 311 constituting the training data 31. The difficulty level parameter 223 in the inference stage is configured to indicate the difficulty level of the new musical piece generated from the target musical piece data 221 by the trained generative model 5.

The difficulty level (degree of difficulty) can be specified in any format. For example, the difficulty level can be set at a plurality of levels (for example “beginner,” “beginner-intermediate,” “intermediate,” “intermediate-advanced,” and “advanced”), and the difficulty level parameters (223, 313) can be configured to indicate any one of these plurality of levels.

In another example, the difficulty level can be specified by the width of a performance sound range. In this case, the difficulty level parameters (223, 313) are configured to indicate the width of the performance sound range of the new musical piece after the difficulty level has been changed.

In another example, the difficulty level can be specified by the maximum number of simultaneously operated operators in a musical instrument used for a performance. In this case, the difficulty level parameters (223, 313) can be configured to indicate the maximum number of simultaneously operated operators in a musical instrument used for the new musical piece after the difficulty level has been changed. The musical instrument used for the musical piece can be selected appropriately in accordance with the implementation. The musical instrument can be a piano, for example. The operator can be the keyboard of a piano, for example. In the difficulty level parameters (223, 313), the difficulty level can be specified relatively or absolutely.

As described above, in the present embodiment, the generative model 5 is configured to generate a new musical piece from an original musical piece that is input based on the difficulty level specified by the difficulty level parameter. By the difficulty level parameter, it is possible to variously control the difficulty level of the newly generated musical piece. As a result, by the model generation device 1, it is possible to generate a trained generative model 5 that has acquired the ability to generate musical pieces with various difficulty levels based on the difficulty level parameter. In the musical piece generation device 2, it is possible to use such a trained generative model 5 to easily generate musical pieces with various difficulty levels.

In the example of FIG. 1, the model generation device 1 and the musical piece generation device 2 are connected to each other via a network. The type of network can be suitably selected from the Internet, a wireless communication network, a mobile communication network, a telephone network, a dedicated network, etc. However, the method of exchanging data between the model generation device 1 and the musical piece generation device 2 is not limited to this example and can be suitably selected in accordance with the implementation. For example, data can be exchanged between the model generation device 1 and the musical piece generation device 2 through the use of a storage medium.

Further, in the example of FIG. 1, the model generation device 1 and the musical piece generation device 2 are separate computers. However, the configuration of the generation system 100 according to the present embodiment is not limited to such an example and can be appropriately determined in accordance with the implementation. For example, the model generation device 1 and the musical piece generation device 2 can be a single computer. Further, for example, at least one of the model generation device 1 or the musical piece generation device 2, or both can be constituted by a plurality of computers. When a plurality of computers are used, the distribution of information processing can be appropriately determined in accordance with the implementation.

### § 2 Configuration Examples

### Hardware Configuration

### <Model Generation Device>

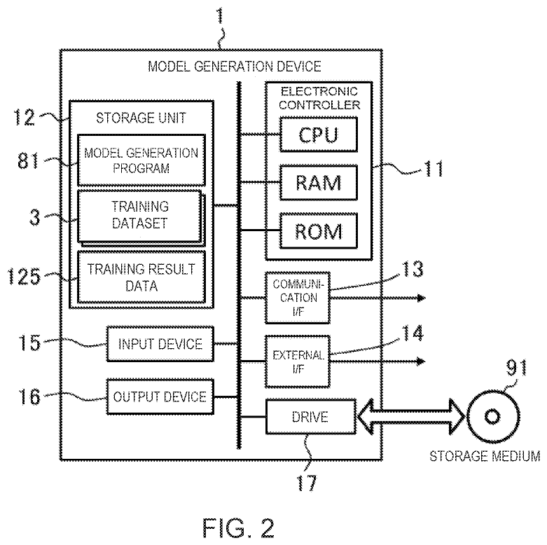

FIG. 2 schematically illustrates one example of the hardware configuration of the model generation device 1 according to the present embodiment. As shown in FIG. 2, the model generation device 1 according to the present embodiment is a computer in which an electronic controller (control unit) 11, a storage unit 12, a communication interface 13, an external interface 14, an input device 15, an output device 16, and a drive 17 are electrically connected. In FIG. 2, the communication interface and the external interface are described as “communication I/F” and “external I/F.”

The electronic controller 11 includes one or processors such as CPUs (Central Processing Unit), a RAM (Random Access Memory), a ROM (Read Only Memory), etc., which are examples of hardware processor resources, and is configured to execute information processing based on programs and various data. The term “electronic controller” as used herein refers to hardware that executes software programs. The storage unit 12 is one example of a memory (computer memory). The storage unit 12 can be any computer storage device or any computer readable medium with the sole exception of a transitory, propagating signal, and can include nonvolatile memory and volatile memory. Any known storage medium, such as a magnetic storage medium or a semiconductor storage medium, or a combination of a plurality of types of storage media can be freely employed as the storage unit 12. For example, the storage unit 12 is for example, a hard disk drive, a solid-state drive, etc. In the present embodiment, the storage unit 12 stores various information, such as a model generation program 81, a plurality of training datasets 3, training result data 125, etc.

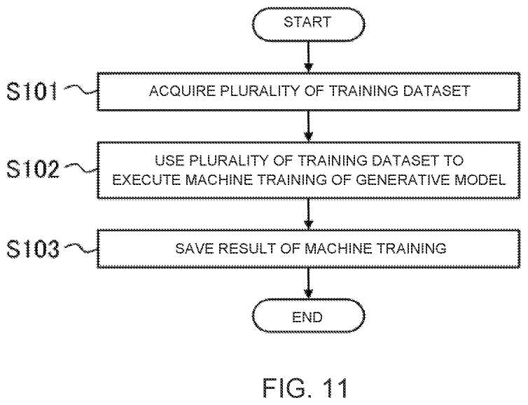

The model generation program 81 causes the model generation device 1 to execute machine learning information processing (FIG. 11), described further below, for generating the trained generative model 5. The model generation program 81 includes a series of instructions for the information processing. The plurality of training datasets 3 are used to generate the trained generative model 5. The training result data 125 indicate information related to the generated trained generative model 5. In the present embodiment, the training result data 125 are generated as a result of executing the model generation program 81. The details will be described further below.

The communication interface 13 is an interface for carrying out wired or wireless communication via a network, such as a wired LAN (Local Area Network) module, a wireless LAN module, etc. The model generation device 1 can use the communication interface 13 to execute data communication via a network with other information processing devices. The external interface 14 is an interface for connecting to an external device, such as a USB (Universal Serial Bus) port, a dedicated port, etc. The type and number of the external interfaces 14 can be arbitrarily selected.

The model generation device 1 can be connected to a device for obtaining each of the training datasets 3 via at least one of the communication interface 13 or the external interface 14, or both. As an example, the training musical piece data 311 constituting the training data 31 can be obtained by an electronic instrument. In this case, the model generation device 1 can be connected to an electronic instrument via the communication interface 13 and/or the external interface 14 and can collect the training musical piece data 311 by the electronic instrument.

The input device 15 is a mouse, keyboard, etc., for inputting data. Further, the output device 16 is a display, speaker, etc., for outputting data. An operator, such as a user, can use the input device 15 and the output device 16 to operate the model generation device 1.

The drive 17 is a CD drive, DVD drive, etc., used to read various information such as programs stored on a storage medium 91. The storage medium 91 accumulates information, such as programs, by electronic, magnetic, optical, mechanical, or chemical actions, such that the computer and other devices and machines can read the various stored information such as programs. The model generation program 81 and/or the training data 3 can be stored on the storage medium 91. The model generation device 1 can acquire the model generation program 81 and/or the plurality of training datasets 3 from the storage medium 91. A disc-type storage medium, such as a CD or a DVD, is shown in FIG. 2 as one example of the storage medium 91. However, the storage medium 91 is not limited to disc-type storage media but can be of a different type. An example of a different type of storage medium besides the disc-type medium is semiconductor memory, such as flash memory. The type of the drive 17 can be arbitrarily selected in accordance with the type of the storage medium 91.

With respect to the specific hardware configuration of the model generation device 1, constituent elements can be omitted, replaced, or supplemented as deemed appropriate in accordance with the implementation. For example, the electronic controller 11 can include a plurality of hardware processors. The electronic controller 12 can include, instead of the CPU or in addition to the CPU, a microprocessor, an FPGA (field-programmable gate array), etc. The storage unit 12 can be constituted by RAM and ROM included in the electronic controller 11. At least one or more of the communication interface 13, the external interface 14, the input device 15, the output device 16, or the drive 17, can be omitted. The model generation device 1 can be constituted by a plurality of computers. Here, the hardware configuration of each computer can or cannot be the same. Moreover, the model generation device 1 can be, in addition to an information processing device designed exclusively for the service to be provided, a general-purpose server device, PC (Personal Computer), etc.

### <Musical Piece Generation Device>

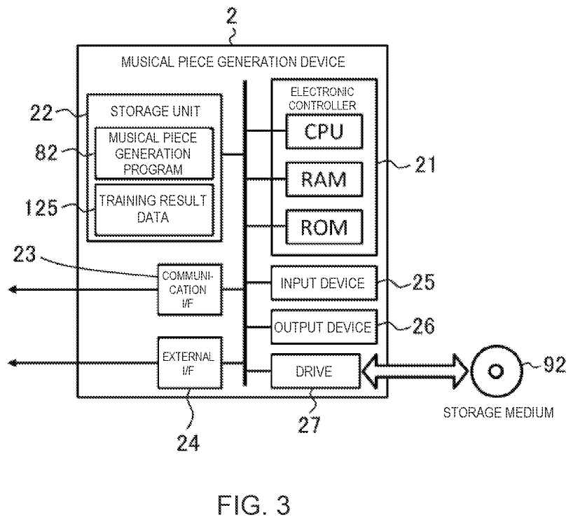

FIG. 3 schematically illustrates one example of the hardware configuration of the musical piece generation device 2 according to the present embodiment. As shown in FIG. 3, the musical piece generation device 2 according to the present embodiment is a computer in which an electronic controller (control unit) 21, a storage unit 22, a communication interface 23, an external interface 24, an input device 25, an output device 26, and a drive 27 are electrically connected.

The electronic controller 21 to the drive 27 of the musical piece generation device 2 and the storage medium 92 can be respectively configured similarly to the electronic controller 11 to the drive 17 of the model generation device 1 and the storage medium 91. The electronic controller 21 includes one or more processor such as CPUs, a RAM, a ROM, etc., which are examples of hardware processor resources, and is configured to execute various information processing based on programs and various data. The term “electronic controller” as used herein refers to hardware that executes software programs. The storage unit 22 is one example of a memory (computer memory). The storage unit 22 can be any computer storage device or any computer readable medium with the sole exception of a transitory, propagating signal, and can include nonvolatile memory and volatile memory. Any known storage medium, such as a magnetic storage medium or a semiconductor storage medium, or a combination of a plurality of types of storage media can be freely employed as the storage unit 22. For example, the storage unit 22 is, for example, a hard disk drive, a solid-state drive, etc. In the present embodiment, the storage unit 22 stores various types of information, such as a musical piece generation program 82, the training result data 125, etc.

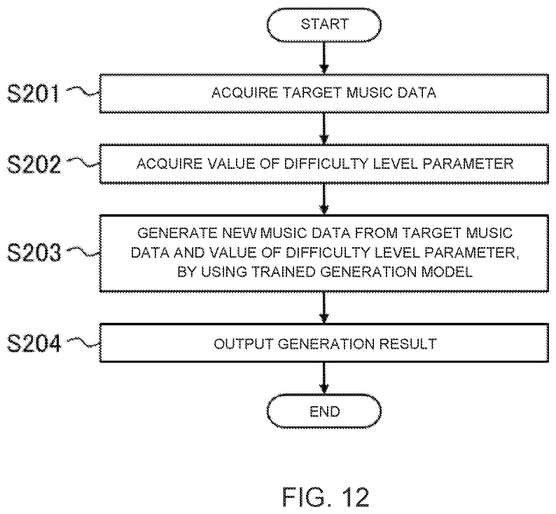

The musical piece generation program 82 causes the musical piece generation device 2 to execute information processing (FIG. 12), described further below, for generating a new musical piece in which the difficulty level of an original musical piece has been changed using the trained generative model 5. The musical piece generation program 82 includes a series of instructions for the information processing. The musical piece generation program 82 and/or the training result data 125 can be stored in the storage medium 92. Further, the musical piece generation device 2 can acquire the musical piece generation program 82 and/or the training result data 125 from the storage medium 92.

The musical piece generation device 2 can be connected to a device for obtaining the target musical piece data 221 via the communication interface 23 and/or the external interface 24. For example, the target musical piece data 221 can be obtained by an electronic instrument. In this case, the musical piece generation device 2 can be connected to the electronic instrument via the communication interface 23 and/or the external interface 24. Further, the musical piece generation device 2 can use the input device 25 and the output device 26 to accept operations and inputs from an operator, such as a user.

With respect to the specific hardware configuration of the musical piece generation device 2, constituent elements can be omitted, replaced, or supplemented as deemed appropriate in accordance with the implementation. For example, the electronic controller 21 can include a plurality of hardware processors. The electronic controller 21 can include, instead of the CPU or in addition to the CPU, a microprocessor, an FPGA, etc. The storage unit 22 can be constituted by RAM and ROM included in the electronic controller 21. At least one or more of the communication interface 23, the external interface 24, the input device 25, the output device 26, or the drive 27 can be omitted. The musical piece generation device 2 can be constituted by a plurality of computers. Here, the hardware configuration of each computer can or cannot be the same. Moreover, the musical piece generation device 2 can be, in addition to an information processing device designed exclusively for the service to be provided, a general-purpose server device, a general-purpose PC, etc.

### Software Configuration

### <Model Generation Device>

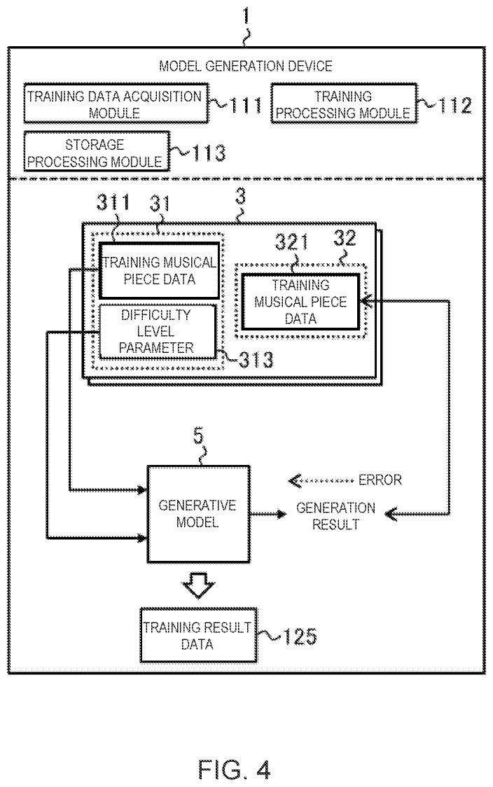

FIG. 4 schematically illustrates one example of the software configuration of the model generation device 1 according to the present embodiment. The electronic controller 11 of the model generation device 1 interprets instructions included in the model generation program 81 stored in the storage device 12 and executes control processes corresponding to the interpreted instructions. The model generation device 1 according to the present embodiment is thus configured to comprise a training data acquisition module 111, a training processing module 112, and a storage processing module 113, as software modules. That is, in the present embodiment, each software module of the model generation device 1 is realized and executed by the electronic controller 11 (CPU).

The training data acquisition module 111 is configured to acquire the plurality of training datasets 3. Each of the training datasets 3 includes a combination of training data 31 and correct answer data 32. The training data 31 are configured to include the training musical piece data 311 indicating at least a part of a musical piece and the difficulty level parameter 313 for training. The correct answer data 32 are configured to include the new training musical piece data 321 indicating at least a part of a new musical piece generated by changing the difficulty level of the musical piece of the training musical piece data 311 to a difficulty level specified by the difficulty level parameter 313.

The training processing module 112 is configured to, by using the acquired plurality of training datasets 3, to execute the machine learning of the generative model 5. The machine learning is configured by training the generative model 5 such that, with respect to each of the training datasets 3, musical piece data generated by the generative model 5 from the training musical piece data 311 and the value of the difficulty level parameter 313 included in the training data 31 match the new training musical piece data 321 included in the correct answer data 32. Upon completion of this machine learning process, the difficulty level of the musical piece indicated by the provided musical piece data is changed to the difficulty level specified by the difficulty level parameter, thereby generating a trained generative model 5 that has acquired the ability to generate a new musical piece (that is, a musical piece in which the difficulty level of the original musical piece has been changed).

The storage processing module 113 is configured to generate information related to the trained generative model 5 generated by the machine learning as the training result data 125 and to store the generated training result data 125 in a prescribed storage area. The training result data 125 can be appropriately configured to include information for reproducing the trained generative model 5.

(An Example of Musical Piece Data)

The musical piece can be acquired in any form, e.g., encoded data (such as MIDI), a musical score, etc. Further, at the time of the processing of the generative model 5, the musical piece can be obtained in a form that is compatible with the processing of the generative model 5. That is, the form of the target musical piece data 221 and the training musical piece data 311 is not particularly limited as long as the data can be processed by the generative model 5 and can be suitably determined in accordance with the implementation. The form of the new musical piece data 225 and the new training musical piece data 321 (correct answer data 32) is not particularly limited as long as the data can be obtained by the generative model 5 and can be suitably determined in accordance with the implementation. As an example, the generative model 5 can be configured to accept an input of at least a part of a musical piece before the difficulty level is changed in the form of a token sequence, and to output the result (inference result) of generating at least a part of a new musical piece in which the difficulty level has been changed in the form of a token sequence. Accordingly, the musical piece can be expressed by token sequences.

If the generative model 5 is configured to handle token sequences, in the training stage, the training musical piece data 311 can include an input token sequence arranged to indicate at least a part of the musical piece (original musical piece) before the difficulty level is changed. The training musical piece data 321 can include true values of an output token sequence arranged to indicate at least a part of a new musical piece obtained by changing the difficulty level (new musical piece generated by changing the difficulty level of the musical piece of the training musical piece data 311 to the difficulty level specified by the difficulty level parameter 313).

Similarly, in the generation (inference) stage, the target musical piece data 221 can include an input token sequence arranged to indicate at least a part of the musical piece (original musical piece) whose difficulty level is to be changed. The new musical piece data 225 generated by the trained generative model 5 can include an output token sequence arranged to indicate at least a part of the new musical piece obtained by changing the difficulty level of the musical piece of the target musical piece data 221 to the difficulty level specified by the difficulty level parameter 223.

Any symbol, such as numbers, characters, graphics, etc., can be used for the tokens constituting the input token sequence and the output token sequence. The symbols (token representations) and data formats used for the tokens are not particularly limited as long as the symbols and data formats can be recognized by a computer and can be suitably selected in accordance with the implementation. As examples of the tokenization method, two tokenization methods, action-based and note-based, will be illustrated below.

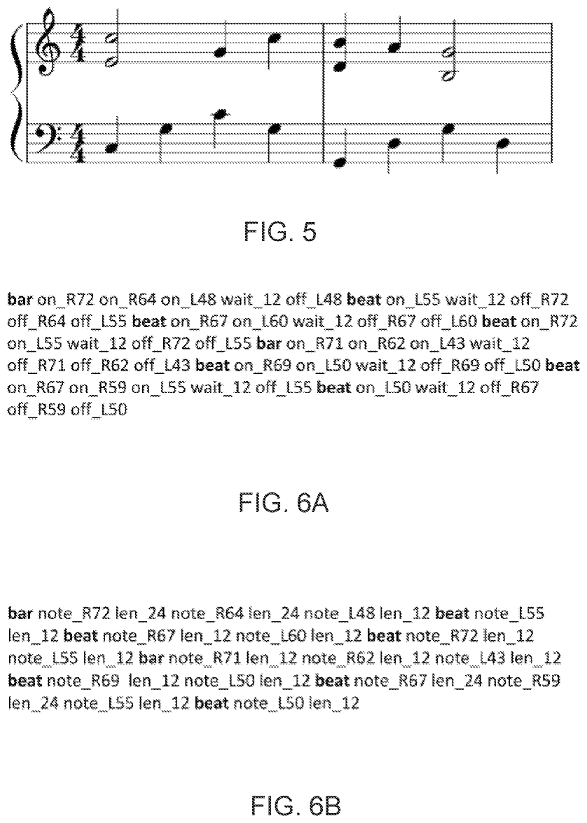

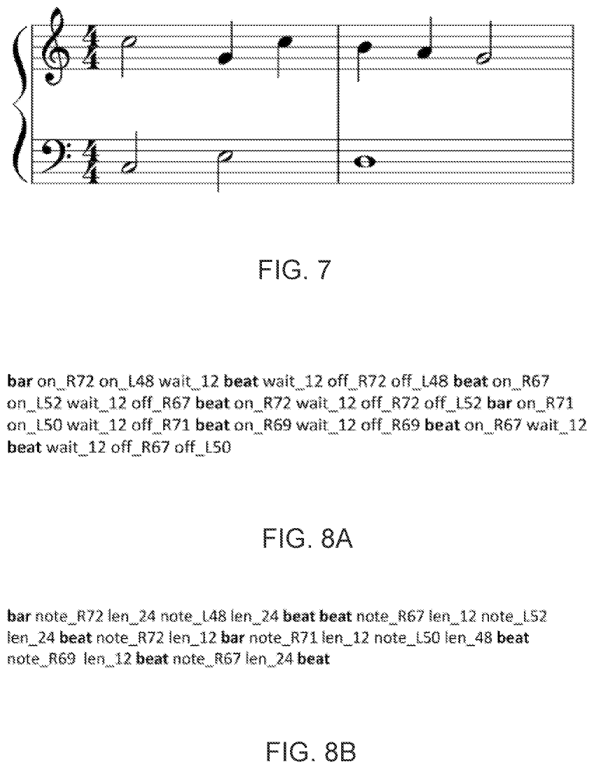

FIG. 5 is a musical score showing an example of at least a part of a musical piece before the difficulty level is changed. FIG. 6A shows one example of an input token sequence generated from the musical piece of FIG. 5 by an action-based tokenization method. FIG. 6B shows an example of an input token sequence generated from the musical piece of FIG. 5 by a note-based tokenization method. FIG. 7 is a musical score showing an example of at least a part of a musical piece after the difficulty level has been changed. FIG. 8A shows an example of true values of an output token sequence obtained corresponding to the musical piece of FIG. 7 by the action-based tokenization method. FIG. 8B shows one example of true values of an output token sequence obtained corresponding to the musical piece of FIG. 7 by the note-based tokenization method.

The action-based tokenization method is a method of tokenization to show actions corresponding to notes or elements of the musical piece. Table 1 shows an example of token types and representations in the action-based tokenization method. On the other hand, the note-based tokenization method is a method of tokenization to show the notes of the musical piece as is. Table 2 shows an example of token types and representations in the note-based tokenization method. The following token types and representations are examples and can be appropriately change in accordance with the implementation.

TABLE 1

| Type | Content | Example of token |
|---|---|---|
| Note on | Keyboard | on_R72, on_R64, on_L48, . . . |
| (keystroke) | depression | |
| Note off | Keyboard release | off_ L48, off_R72, off_R64, . . . |
| (key release) | | |
| Delta time | Allow time to | wait_12, . . . |
| (time difference) | elapse (wait) | |

TABLE 2

| Classification | Content | Example of token |
|---|---|---|
| Note Pitch | Pitch of | note_R72, note_R64, note_L48, . . . |
| (pitch) | sound | |
| Note value | Sound | len_24, len_12, . . . |
| (phonetic value) | length | |

Either one of the two methods described above can be employed as the tokenization method and token representation of the input token sequence and the output token sequence. As an example of a method of acquiring each of the training datasets 3, performance information indicating at least a part of the musical piece illustrated in FIG. 5 can be suitably acquired. The data format of the performance information can be suitably selected in accordance with the implementation. As an example, the performance information can be acquired in a form such as encoded data (MIDI, etc.) or a musical score. The training musical piece data 311 in the training data 31 of each of the training datasets 3 can be suitably generated so as to include the input token sequence shown in FIG. 6A and FIG. 6B from the obtained performance information. Further, in accordance with at least a part of the musical piece illustrated in FIG. 5, correct answer performance information indicating the true value of the musical piece after the difficulty level has been changed, illustrated in FIG. 7, can be suitably obtained. The new training musical piece data 321 constituting the correct answer data 32 of each of the training datasets 3 can be suitably generated so as to include the true value of the output token sequence shown in FIG. 8A or FIG. 8B from the obtained correct answer performance information. Any conversion process, such as natural language processing, can be employed for the generation of the true values of the input token sequence and the output token sequence. The true values of the input token sequence and the output token sequence can be generated manually by a person.

Further, the input token sequence can include a plurality of metrical tokens that are each arranged to indicate the metrical positions of the musical piece. Thus, the input token sequence can be configured so as to be capable of specifying the metrical structure of the musical piece. Of the tokens included in the input token sequence illustrated in FIGS. 6A and 6B, “bar” and “beat” are examples of metrical tokens. “bar” is one example of a token indicating a bar line, and “beat” is one example of a token indicating a beat (time signature).

Metrical tokens are arranged in the input token sequence to indicate the positions of the bar lines and/or the beats of the musical piece. The bar line indicates a break between bars. Bars are divisions of appropriate length that make the musical score easier to read. A beat is a unit that divides the temporal continuity of music.

In one example, each metrical token can be arranged to indicate either a bar line or a beat. As a result, it is possible to ascertain the metrical structure of the musical piece using the metrical tokens as a cue. However, the metrical structure varies from one musical piece to another. There are musical pieces in which the meter changes in the middle of the musical piece. It is difficult to completely ascertain the metrical structure of various types of musical pieces using only either bar lines or beats. Thus, the metrical tokens are preferably arranged at each bar line and beat in the input token sequence.

As illustrated in FIGS. 8A and 8B, the output token sequence can also include a plurality of metrical tokens each arranged to indicate the positions of the beats of the newly generated musical piece (that is, the musical piece after the difficulty level has been changed). The generative model 5 can be configured to output an output token sequence including metrical tokens as a result of generating a new musical piece after the difficulty level has been changed. Like the input token sequence, in one example, each metrical token can be arranged to indicate a bar line and/or a beat in the output token sequence. The metrical tokens are preferably positioned at the respective bar line and beat in the output token sequence.

Here, the representations (“bar,” “beat”) of the metrical tokens in FIGS. 6A, 6B, 8A, and 8B are examples. The representations of the metrical tokens are not limited to these examples and can be appropriately determined in accordance with the implementation. Any symbol, such as numbers, characters, graphics, etc., can be used for the metrical tokens. The symbols and data formats used for the metrical tokens are not particularly limited as long as the symbols and data can be recognized by a computer and can be suitably selected in accordance with the implementation.

The same tokenization method and the same token representation can be used for the input token sequence and the output token sequence. In the above-described example, both the input token sequence and the output token sequence can employ an action-based or note-based tokenization method. However, the input token sequence and the output token sequence are not limited to such examples. It is not necessary for the input token sequence and the output token sequence to use the same tokenization method and the same token representation. The input token sequence and the output token sequence can employ different tokenization methods, or different token representations.

As long as a computer can recognize at least a part of the musical piece whose difficulty level is to be changed, the form of the tokens employed for the input token sequence is not particularly limited and can be appropriately determined in accordance with the implementation. As long as a computer can recognize the result of the generated new musical piece after the difficulty level has been changed, the form of the tokens employed for the output token sequence is not particularly limited and can be appropriately determined in accordance with the implementation. Further, as long as a computer can recognize the metrical structure, the form of the metrical tokens is not particularly limited and can be appropriately determined in accordance with the implementation. Similarly, the difficulty level parameter can also be expressed in the form of tokens.

(An Example of a Generative Model)

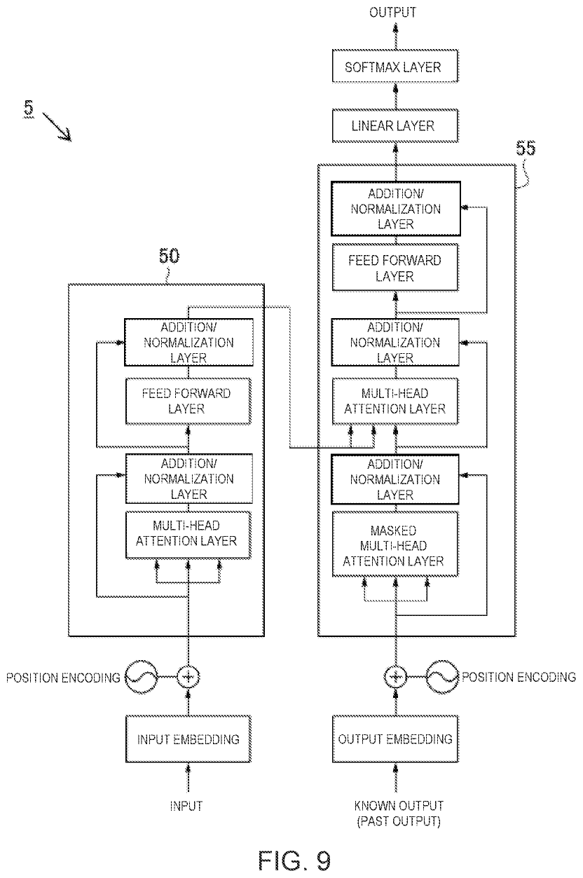

FIG. 9 schematically illustrates an example of the configuration of the generative model 5 according to the present embodiment. The generative model 5 is configured by a machine learning model that has machine learning-adjusted parameters. The type of machine learning model is not particularly limited and can be appropriately selected in accordance with the implementation. As long as the implementation is configured to accept an input of a difficulty level parameter and the original musical piece whose difficulty level is to be changed and to output the result of generating a new musical piece obtained by changing the difficulty level of the original musical piece to the difficulty level specified by the difficulty level parameter, the structure of the machine learning model is not particularly limited and can be appropriately determined in accordance with the implementation. As an example, the machine learning model can be configured to accept input of the original musical piece in the form of a token sequence and to output the result of the generated new musical piece in the form of a token sequence. As an example of the structure of the machine learning model in this case, as shown in FIG. 9, the generative model 5 can have a configuration based on a Transformer as proposed in the reference document “Ashish Vaswani, Noam Shazeer, Niki Parmar, Jakob Uszkoreit, Llion Jones, Aidan N Gomez, Lukasz Kaiser, and Illia Polosukhin. Attention is all you need. In Advances in Neural Information Processing Systems, 2017.” A Transformer is a machine learning model that processes serial data (natural language, etc.) and has an attention-based structure.

In the example of FIG. 9, the generative model 5 has an encoder 50 and a decoder 55. The encoder 50 has a structure constituted by a plurality of stacked blocks, each having a multi-head attention layer that seeks self-attention, and a feed-forward layer. The decoder 55, on the other hand, has a structure constituted by a stacked a plurality of blocks, each having a masked multi-head attention layer that seeks self-attention, a multi-head attention layer that seeks source/target attention, and a feed-forward layer. As shown in FIG. 9, each of the layers of the encoder 50 and the decoder 55 can have an addition and normalization layer. Each layer can include one or more nodes, and a threshold value can be set for each node. The threshold value can be represented by an activation function. Further, a weight (connection load) can be set for the connections between nodes of adjacent layers. The threshold value and the weights of the connections between nodes are examples of the parameters of the generative model 5.

In one example of FIG. 9, the generative model 5 is configured to receive tokens included in the input token sequence in order from the beginning. The tokens input to the generative model 5 are each converted into vectors having a prescribed number of dimensions by an input embedding process and are provided with a value specifying the position within the musical piece (within the phrase) by a position encoding process, and are thereafter input to the encoder 50. The encoder 50 continually carries out processing by the multi-head attention layer and the feed-forward layer for the number of blocks in response to this input to acquire a feature representation and supplies the acquired feature expression to the decoder 55 (multi-head attention layer) of the next stage. The difficulty level parameter can be input to the generative model 5 at any timing. In one example, the difficulty level parameter can be input before the input token sequence.

In addition to the input from the encoder 50, known (past) outputs from the decoder 55 (masked multi-head attention layer) are supplied to the decoder 55. That is, the generative model 5 illustrated in FIG. 9 is configured to have a recursive structure. In response to this input, the decoder 55 repeatedly executes processing by the masked multi-head attention layer, the multi-head attention layer, and the feed-forward layer for the number of blocks to acquire and output a feature representation. The output from the decoder 55 is transformed in a linear layer and a softmax layer to obtain tokens representing the result of the generated new musical piece.

The training processing module 112 is configured to perform machine learning of the generative model 5 using the training data 31 as input data and the corresponding correct answer data 32 (true values of the output token sequence) as teacher signals for each of the training datasets 3. Specifically, the training processing module 112 is configured to train the generative model 5 such that the output token sequence, which is obtained by inputting the training musical piece data 311 (input token sequence) and the difficulty level parameter 313 included in the training data 31 to the generative model 5 and performing the arithmetic operations of the generative model 5, matches the new training musical piece data 321 (true values of the output token sequence) of the corresponding correct answer data 32, for each of the training datasets 3. In other words, the training processing module 112 is configured to adjust the parameter values of the generative model 5, such that the error between the output token sequence generated from the training musical piece data 311 and the difficulty level parameter 313, and the true values indicated by the corresponding correct answer data 32, is minimized for each of the training datasets 3. Any method, such as an error backpropagation method, can be used for the parameter adjustment. Further, a plurality of normalization methods (e.g., label smoothing, residual dropout, attention dropout) can be applied to the processing of the machine learning of the generative model 5.

### <Musical Piece Generation Device>

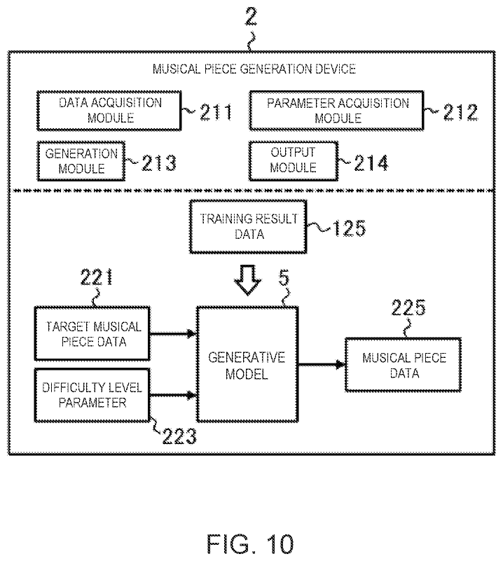

FIG. 10 schematically illustrates one example of the software configuration of the musical piece generation device 2 according to the present embodiment. The electronic controller 21 of the musical piece generation device 2 interprets instructions contained in the musical piece generation program 82 stored in the storage device 22 and executes control processes corresponding to the interpreted instructions. The musical piece generation device 2 according to the present embodiment is thus configured to comprise a data acquisition module 211, a parameter acquisition module 212, a generation module 213, and an output module 214, as software modules. That is, in the present embodiment, each software module of the musical piece generation device 2 is realized and executed by the electronic controller 21 (CPU), in the same manner as the model generation device 1.

The data acquisition module 211 is configured to acquire the target musical piece data 221 indicating at least a part of the musical piece whose difficulty level is to be changed. If the generative model 5 is configured to treat token sequences, the target musical piece data 221 can be configured to include an input token sequence arranged to indicate at least a part of the musical piece. In this case, the input token sequence included in the target musical piece data 221 can be obtained in the same form as the training musical piece data 311 of the training data 31 illustrated in FIGS. 6A and 6B. The input token sequence included in the target musical piece data 221 can include a plurality of metrical tokens each arranged to indicate the positions of beats of the musical piece. In one example, each metrical token can be arranged to indicate a bar line and/or a beat in input token sequence. The metrical tokens are preferably arranged at each bar line and beat in the input token sequence.

The parameter acquisition module 212 acquires a value of the difficulty level parameter 223 for specifying the difficulty level of the musical piece following a change. The value of the difficulty level parameter 223 can be specified manually or by computer processing. The value of the difficulty level parameter 223 can be acquired by any arbitrary method.

The generation module 213 holds the training result data 125 and is thus provided with the trained generative model 5. The generation module 213 uses the trained generative model 5 to generate, from the acquired target musical piece data 221 and the value of the difficulty level parameter 223, new musical piece data 225 indicating at least a part of a new musical piece obtained by changing the difficulty level of the musical piece to the difficulty level specified by the difficulty level parameter 223.

In the example of FIG. 9, the generation module 213 sequentially inputs the input token sequence included in the target musical piece data 221 and the value of the difficulty level parameter 223 to the encoder 50 of the trained generative model 5 (specifically, to the multi-head attention layer located first after the input embedding layer) and executes the arithmetic processing of the encoder 50 and the decoder 55. As a result of this arithmetic processing, the generation module 213 sequentially acquires the tokens output from the trained generative model 5 (in the example of FIG. 9, the softmax layer located last) to generate the output token sequence constituting the new musical piece data 225.

At the time of this processing, the output token sequence can be generated using a search method such as beam search. More specifically, to generate the output token sequence, the generation module 213 can retain n candidate tokens in descending order of the score from the probability distribution of the values output from the generative model 5 and select the candidate tokens such that the total score of m consecutive tokens is highest (where n, m are integers greater than or equal to 2).

The generated output token sequence can be obtained in the same form as the new training musical piece data 321 of the correct answer data 32 illustrated in FIGS. 8A and 8B. The output token sequence included in the new musical piece data 225 can include a plurality of metrical tokens each arranged to indicate the positions of beats of the musical piece. In one example, each metrical token can be arranged to indicate a bar line and/or a beat in the output token sequence. The metrical tokens are preferably arranged at each bar line and beat in the output token sequence.

The output module 214 is configured to output the generated new musical piece data 225. The output form of the new musical piece data 225 is not particularly limited and can be appropriately determined in accordance with the implementation. As an example, in the case that the new musical piece data 225 are constituted by output token sequences, the output token sequences can be output as is. As another example, the output token sequence can be converted to a suitable form, and information obtained by the conversion can be output.

### <Other>

Each of the software modules of the model generation device 1 and the musical piece generation device 2 according to the present embodiment will be described in detail in the operation example described further below. In the present embodiment, an example in which each software module of the model generation device 1 and the musical piece generation device 2 is realized by a general-purpose CPU is described. However, some or all of the software modules can be realized by one or more dedicated processors (e.g., application-specific integrated circuits (ASIC)). Each of the modules described above can also be realized as a hardware module. Further, with respect to the software configuration of the model generation device 1 and the musical piece generation device 2, the software modules can be omitted, replaced, or supplemented as deemed appropriate in accordance with the implementation.

### § 3 Operation Example

### <Model Generation Device>

FIG. 11 is a flowchart showing one example of the processing procedure of the model generation device 1 according to the present embodiment. The processing procedure of the model generation device 1 described below is one example of the model generation method. However, the processing procedure of the model generation device 1 described below is merely an example, and each step can be modified to the extent possible. The steps of the following processing procedure can be omitted, replaced, or supplemented as deemed appropriate in accordance with the implementation.

(Step S101)

In Step S101, the electronic controller 11 acquires the plurality of training datasets 3, each constituted by a combination of the training data 31 and the correct answer data 32.

The training datasets 3 can be generated as required. The training musical piece data 311 of the training data 31 can be suitably generated so as to indicate at least a part of the musical piece before the difficulty level is changed. The new training musical piece data 321 of the correct answer data 32 can be suitably generated so as to indicate at least a part of the musical piece after the difficulty level has been changed. In one example, the training musical piece data 311 can be generated so as to include the input token sequence shown in FIG. 6A or 6B, and the new training musical piece data 321 can be generated so as to include the true values of the output token sequence shown in FIG. 8A or 8B. Each token sequence can be generated from performance information of another form, such as encoded data or a musical score. Alternatively, each token sequence can be directly generated.

The difficulty level parameter 313 for training of the training data 31 can be suitably generated so as to indicate the difficulty level following a change (that is, the difficulty level of the musical piece indicated by the corresponding correct answer data 32). In one example, the difficulty level parameter 313 can be configured to indicate any one of a plurality of difficulty levels. In another example, the value of the difficulty level parameter 313 can be set in accordance with one or a plurality of factors related to the difficulty level. As a specific example, the difficulty level parameter 313 can be configured to indicate the width of the performance sound range of the new musical piece after the difficulty level has been changed and/or the maximum number of simultaneously operated operators in the musical instrument used for the new musical piece. Each of the training datasets 3 can be generated by associating the corresponding training data 31 and the correct answer data 32 with each other.

The process for generating the training datasets 3 can be performed on any computer. In one example, the process for generating each of the training datasets 3 can be executed by the model generation device 1 (electronic controller 11). In another example, at least a part of the plurality of training datasets 3 can be generated by another computer. In this case, the model generation device 1 (electronic controller 11) can acquire the training datasets 3 generated by the other computer via a network, the storage medium 91, or the like. The sufficient number of training datasets 3 to ensure machine learning to be acquired can be suitably determined. When the plurality of training datasets 3 are acquired, the electronic controller 11 advances the process to the next Step S102.

(Step S102)

In Step S102, the electronic controller 11 operates as the training processing module 112 and executes the machine learning of the generative model 5 by using the acquired plurality of training datasets 3.

As an example of a specific process of machine learning, the electronic controller 11 sequentially inputs the training musical piece data 311 and the value of the difficulty level parameter 313 included in the training data 31 of each of the training datasets 3 to the generative model 5, repeatedly executes the arithmetic processing of the generative model 5, and sequentially acquires the output tokens. By this arithmetic processing, the electronic controller 11 is able to obtain the output token sequence indicating the result of the generated new musical piece after the difficulty level has been changed, corresponding to the training data 31. The electronic controller 11 then calculates the error between the obtained output token sequence and the true value indicated by the new training musical piece data 321 included in the corresponding correct answer data 32 and also calculates the gradient of the calculated error. The electronic controller 11 uses the error backpropagation method to backpropagate the slope of the calculated error to calculate the error of the parameter value of the generative model 5. The electronic controller 11 adjusts the parameter value of the generative model 5 based on the calculated error. The electronic controller 1I can repeat the adjustment of the parameter values of the generative model 5 by the series of processes described above until a prescribed condition is met (e.g., until the process is performed a specified number of time, or the sum of the calculated errors is less than or equal to a threshold value).

By this machine learning, the generative model 5 is trained such that, with respect to each of the training datasets 3, musical piece data generated from the training musical piece data 311 and the value of the difficulty level parameter 313 included in the training data 31 match the new training musical piece data 321 included in the correct answer data 32. Therefore, as a result of machine learning, the difficulty level of the musical piece that is provided is changed to the difficulty level specified by the difficulty level parameter, thereby generating a trained generative model 5 that has acquired the ability to generate a new musical piece. When the machine learning process is completed, the electronic controller 11 advances the process to the next Step S103.

(Step S103)

In Step S103, the electronic controller 11 operates as the storage processing module 113 and generates information related to the trained generative model 5 generated by machine learning as the training result data 125. The training result data 125 holds information for reproducing the trained generative model 5. As one example, the training result data 125 can include information that indicates the value of each parameter of the generative model 5 obtained by the adjustment of the machine learning described above. In some cases, the training result data 125 can include information that indicates the structure of the generative model 5. For example, the structure can be specified by the number of layers, the type of layer, the number of nodes in each layer, the connection relationship between nodes of adjacent layers, etc. The electronic controller 11 stores the generated training result data 125 in a prescribed storage area.

The prescribed storage area can be the RAM in electronic controller 11, the storage unit 12, the external storage device, a storage medium, or a combination thereof. The storage medium can be a CD, a DVD, etc., and the electronic controller 11 can store the training result data 125 in the storage medium via the drive 17. The external storage device can be a data server, such as NAS. In this case, the electronic controller 11 can use the communication interface 13 to store the training result data 125 in the data server via a network. Further, the external storage device can be an external storage device connected to the model generation device 1, for example.

Once the training result data 125 are stored, the electronic controller 11 ends the processing procedure of the model generation device 1 according to the present operation example.

The generated training result data 125 can be provided to the musical piece generation device 2 at any timing. For example, the electronic controller 11 can transfer the training result data 125 to the musical piece generation device 2 as a process of Step S103 or separately from the process of Step S103. The musical piece generation device 2 can receive this transfer to acquire the training result data 125. Further, for example, the musical piece generation device 2 can use the communication interface 23 and access the model generation device 1 or a data server via a network, to acquire the training result data 125. Further, for example, the musical piece generation device 2 can acquire the training result data 125 via the storage medium 92. Further, for example, the training result data 125 can be incorporated in the musical piece generation device 2 in advance.

Further, the electronic controller 11 can repeat the processes of Steps S101-S103 periodically or at irregular intervals to update or generate new training result data 125. At the time of this repetition, at least part of the plurality of training datasets 3 used for the machine learning can be changed, modified, supplemented, deleted, etc., as deemed appropriate. The electronic controller 11 can thereby update or regenerate the trained generative model 5. The electronic controller 11 can then provide the updated or newly generated training result data 125 to the musical piece generation device 2 by any means to update the training result data 125 held by the musical piece generation device 2.

### <Musical Piece Generation Device>

FIG. 12 is a flowchart showing an example of a processing procedure of the musical piece generation device 2 according to the present embodiment. The processing procedure of the musical piece generation device 2 described below is an example of the musical piece generation method. However, the processing procedure of the musical piece generation device 2 described below is merely an example, and each step thereof can be modified as much as possible. With respect to the following processing procedure, the steps can be omitted, replaced, or supplemented as deemed appropriate in accordance with the implementation.

(Step S201)

In Step S201, the electronic controller 21 operates as the data acquisition module 211 and acquires the target musical piece data 221 indicating at least a part of a musical piece.

The target musical piece data 221 can be generated as required. In one example, the target musical piece data 221 can be configured so as to include an input token sequence arranged to indicate at least a part of the musical piece. In this case, the input token sequence can be generated from performance information of another form, such as encoded data or a musical score. Alternatively, the input token sequence can be directly generated.

Further, the target musical piece data 221 can be acquired via any route. As an example, the target musical piece data 221 can be generated by the musical piece generation device 2. In this case, the electronic controller 21 can acquire the target musical piece data 221 as a result of executing the generation process. In another example, generation of the target musical piece data 221 can be executed by a computer other than the musical piece generation device 2. In this case, the electronic controller 21 can acquire the target musical piece data 221 via a network, the storage medium 92, or the like. Once the target musical piece data 221 is acquired, the electronic controller 21 advances the process to the next Step S202.

(Step S202)

In Step S202, the electronic controller 21 operates as the parameter acquisition module 212 and acquires the value of the difficulty level parameter 223.

The value of the difficulty level parameter 223 can be acquired by any method. The value of the difficulty level parameter 223 can be acquired by methods such as manual input by an operator, selection from a list of possible difficulty levels that can be specified, random selection, determination in accordance with an arbitrary rule, etc.

Similarly to the training data 31, in one example, the value of the difficulty level parameter 223 can be configured to indicate any one of a plurality of difficulty levels. In another example, the value of the difficulty level parameter 223 can be set in accordance with one or a plurality of factors related to the difficulty level. As a specific example, the value of the difficulty level parameter 223 can be configured to indicate the width of the performance sound range of the new musical piece after the difficulty level has been changed and/or the maximum number of simultaneously operated operators in the musical instrument used for the new musical piece.

When the value of the difficulty level parameter 223 is acquired, the electronic controller 21 advances the process to the next Step S203. The timings for executing the processes of Step S201 and Step S202 are not limited to such an example. In another example, the process of Step S202 can be executed before Step S201. In yet another example, the processed of Step S201 and Step S202 can be executed in parallel.

(Step S203)

In Step S203, the electronic controller 21 operates as the generation module 213 and refers to the training result data 125 to set up the trained generative model 5 by machine learning. The electronic controller 21 uses the trained generative model 5 to generate, from the acquired target musical piece data 221 and the value of the difficulty level parameter 223, the new musical piece data 225 indicating at least a part of a new musical piece obtained by changing the difficulty level of the musical piece to the difficulty level specified by the difficulty level parameter 223.

In one example, the electronic controller 21 inputs the input token sequence included in the target musical piece data 221 and the value of the difficulty level parameter 223 to the trained generative model 5, and executes the arithmetic processing of the trained generative model 5. In the example of FIG. 9 above, the electronic controller 21 sequentially inputs the input token sequence and the value of the difficulty level parameter 223 to the trained generative model 5, and repeatedly executes the feedforward arithmetic processing of the trained generative model 5, to sequentially generate the tokens that constitute the output token sequence. As a result of this arithmetic processing, the electronic controller 21 acquires from the trained generative model 5 the new musical piece data 225 including the output token sequence. When the generation of the new musical piece by changing the difficulty level (arithmetic processing of the trained generative model 5) is completed, the electronic controller 21 advances the process to the next Step S204.

(Step S204)

In Step S204, the electronic controller 21 operates as the output module 214 and outputs the new musical piece data 225 generated by the process of Step S203. The output destination and the output form are not particularly limited and can be appropriately determined in accordance with the implementation. In one example, the output destination can be the RAM, the storage unit 22, a storage medium, an external storage device, another computer, another device, or the like. In one example, the electronic controller 21 can output the obtained new musical piece data 225 (for example, an output token sequence) as is. In another example, the electronic controller 21 can convert the new musical piece data 225 into a suitable form and output the information obtained by the conversion. As a specific example, in the case that the new musical piece data 225 is obtained in the form of an output token sequence, the electronic controller 21 can convert the obtained output token sequence into a musical score and output the obtained musical score. In this case, the electronic controller 21 can output an instruction to a printing device (not shown) to print the musical score on a paper medium.

When the output of the generated new musical piece data 225 is completed, the electronic controller 21 ends the processing procedure of the musical piece generation device 2 according to the present operation example. The electronic controller 21 can repeatedly execute the processes of Steps S201-S204 periodically or at irregular intervals, in accordance with an operator's request. At the time of this repetition, at least part of the target musical piece data 221 obtained in Step S201 and/or the value of the difficulty level parameter 223 obtained in Step S202 can be changed, modified, supplemented, deleted, etc., as deemed appropriate. In this way, the electronic controller 21 can use the trained generative model 5 to generate different variations of musical pieces in which the difficulty level has been changed.

### <Characteristics>

As described above, in the present embodiment, the training data 31 of each of the training datasets 3 used for the machine learning of Step S102 described above are configured to include the difficulty level parameter 313 for training, which indicates the difficulty level following a change. As a result, the generative model 5 is trained to generate a new musical piece (new training musical piece data 321) from an original musical piece that is input (training musical piece data 311) based on the difficulty level specified by the difficulty level parameter 313. By the difficulty level parameter, the difficulty level of the newly generated musical piece can be controlled in a variety of ways. Therefore, by the machine learning process of Step S102, the trained generative model 5 that has acquired the ability to generate musical pieces with various difficulty levels based on the difficulty level parameter can be generated.

In Step S202 described above, the value of the difficulty level parameter 223 is acquired in order to specify the difficulty level following a change. Then, in Step S203, the acquired value of the difficulty level parameter 223 is used for the process of generating the new musical piece by the trained generative model 5. As a result, the trained generative model 5 can execute a process for changing the difficulty level of the musical piece indicated by the target musical piece data 221 in accordance with the value of the difficulty level parameter 223. As a result, musical pieces with various difficulty levels can be easily generated.

Further, in the present embodiment, the values of the difficulty level parameters (223, 313) can be configured to indicate the width of the performance sound range of the new musical piece after the difficulty level has been changed and/or the maximum number of simultaneously operated operators in the musical instrument used for the new musical piece. As a result, in the machine learning process of Step S102, the trained generative model 5 that has acquired the ability to control, by the difficulty level parameter, the performance sound range width of the generated new musical piece and/or the maximum number of operators can be generated. In the generation process of Step S203, musical pieces with various performance sound range widths and/or musical pieces with various maximum numbers of operators can be easily generated.

Further, in the present embodiment, the generative model 5 can be configured to accept the input of musical pieces in the form of token sequences. The input token sequence (target musical piece data 221 and training musical piece data 311) can then be configured to include a plurality of metrical tokens arranged to indicate the positions of the beats of the musical piece. This allows the generative model 5 to execute the process of generating the new musical piece based on the understanding of the metrical structure of the musical piece through the metrical tokens. As a result, in the machine learning process of Step S102, it is possible to generate the trained generative model 5 in which temporal errors caused by the metrical structure are less likely to occur. In the generation process of Step S203, it is possible to reduce the probability of the occurrence of temporal errors in the generated new musical piece (new musical piece data 225).

Further, in the present embodiment, the generative model 5 can be configured to output the generated new musical piece in the form of tokens. The output token sequence (new musical piece data 225 and new training musical piece data 321) can then be configured to include a plurality of metrical tokens arranged to indicate the positions of the beats of the musical piece, in the same manner as the input token sequence. As a result, even if a temporal error occurs in the generation process of Step S203, it is possible to easily identify the location where the temporal error occurred based on the position of the metrical token included in the output token sequence. As a result, it is possible to easily correct the obtained new musical piece. By the machine learning process of Step S102, it is possible to generate the trained generative model 5 having such a capability.

### § 4 Modification

An embodiment of this disclosure has been described above in detail, but the above-mentioned description is merely an example of this disclosure in all respects. Various refinements and modifications can, of course, be made without deviating from the scope of this disclosure.

For example, in the present embodiment, a machine learning model (FIG. 9) having the recursive structure of a Transformer is presented as an example of the generative model 5. However, the recursive structure is not limited to the example shown in FIG. 9. A recursive structure indicates a structure that is configured to enable processing with respect to the target (current) input by referring to inputs prior to the target. As long as such computations are possible, the recursive structure need not be limited and can be suitably determined in accordance with the implementation. In another example, the recursive structure can be configured in accordance with a known structure, such as an RNN (Recurrent Neural Network), LSTM (Long short-term memory), etc.

In the embodiment described above, the generative model 5 is configured to have a recursive structure. However, the configuration of the generative model 5 is not limited to this example. The recursive structure can be omitted. The generative model 5 can be configured in accordance with a neural network having a known structure such as a fully connected neural network or a convolutional neural network. Further, the mode of inputting the input token sequence to the generative model 5 is not limited to the example of the embodiment described above. In another example, the generative model 5 can be configured to receive a plurality of tokens contained in the input token sequence at one time.

In the embodiment described above, the input and output data format of the generative model 5 is not limited to token sequences, and any data format can be employed. As long as the input of the musical piece and the difficulty level parameter can be accepted and a new musical piece after the difficulty level has been changed can be output, the type of machine learning model that constitutes the generative model 5 need not be limited and can be suitably selected in accordance with the implementation. In the embodiment described above, in the case that the generative model 5 is configured by a machine learning model having a plurality of layers, the type of each layer can be suitably selected in accordance with the implementation. A convolution layer, a pooling layer, a dropout layer, a normalized layer, a fully connected layer, etc., can be used for each layer. The constituent elements of the structure of the generative model 5 can be omitted, replaced, or supplemented as required. Further, the generative model 5 can be configured to also accept input of information other than the above-described musical piece and the difficulty level parameter. The generative model 5 can be configured to also output information other than the above-described new musical piece.

### § 5 Reference Example

In order to verify the validity of the metrical tokens, trained generative models according to a first reference example and a second reference example were generated, and accuracy of the generated trained generative models was evaluated.

Specifically, 261,396 samples of original musical pieces were prepared, and the action-based tokenization method shown in Table 1, FIG. 6A, and FIG. 8A was employed to generate an input token sequence constituting training data from the musical pieces of each prepared sample. Further, musical pieces in which the difficulty levels of the 261,396 samples, each corresponding to the original musical pieces were prepared. Then, in the same manner as the input token sequence, an action-based tokenization method was employed to generate true values of the output token sequence constituting the correct answer data were generated from each sample of the musical pieces after the difficulty levels were changed. The generated input token sequence (training data) and true values of the output token sequence (correct answer data) were associated with each other to generate a training dataset of 261,396 samples. As shown in FIGS. 6A and 8A, in the first reference example, the training dataset was obtained by placing a metrical token at the position of the bar line and the beat for each true value of the input token sequence and the output token sequence. In the second reference example, on the other hand, the training dataset was obtained without placing a metrical token in either the input token sequence or the output token sequence (other conditions were the same as in the first reference example).

The Transformer illustrated in FIG. 9 was employed as the structure of the generative model according to the first reference example and the second reference example. By the same method as the embodiment described above, the training dataset of the prepared 261,396 samples was used to execute machine learning to generate the trained generative models according to the first reference example and the second reference example.

Separately from the training data, a musical piece of 1.000 samples (each sample has a time length of 4 bars) was prepared to obtain an input token sequence (target musical piece data) of 1,000 samples from the prepared musical piece. In the same manner as the training dataset, each metrical token was placed at the positions of the bar lines and the beats in the input token sequence according to the first reference example. On the other hand, metrical tokens were not placed in the input token sequence according to the second reference example (other conditions were the same as in the first reference example).

Next, output token sequences indicating new musical piece data were obtained from the target musical piece data of each sample using the trained generative model of each of the first reference example and the second reference example. Then, with respect to the original musical piece (that is, the musical piece indicated by the target musical piece data), it was evaluated whether there was deviation in the number of beats in the musical piece after the difficulty level was changed, indicated by the output token sequence. As a result, in the second reference example, deviations in the number of beats occurred with a probability of 17.4%. On the other hand, in the first reference example, deviations in the number of beats occurred with a probability of 4.1%. From this result, it was found that the probability of occurrence of temporal errors can be greatly reduced by entering metrical tokens indicating the metrical structure.

### § 6 Additional Statement

A musical piece generation device according to one aspect of this disclosure comprises a data acquisition module configured to acquire target musical piece data indicating at least part of a musical piece, a parameter acquisition module configured to acquire a value of a difficulty level parameter for specifying the difficulty level of the musical piece after a change, a generation module configured to, by using a trained generative model, generate new musical piece data indicating at least part of a new musical piece obtained by changing the difficulty level of the musical piece to the difficulty level specified by the difficulty level parameter, from the acquired target musical piece data and a value of the difficulty level parameter, and an output module for outputting the generated new musical piece data.

In said configuration, a difficulty level parameter is used for an inference process for generating a new musical piece. By the difficulty level parameter, it is possible to variously control the difficulty level of the newly generated musical piece. For example, by setting the difficulty level specified by the difficulty level parameter in a multi-stage manner, it is possible to generate a new musical piece in accordance with each of the specified difficulty level. Further, it is possible to generate, not only a musical piece with a lower difficulty level but also a musical piece with a higher difficulty level. That is, it is possible to specify the difficulty level using the difficulty level parameter to adjust the level of the new musical piece, such as increasing or decreasing the difficulty level, for example. Accordingly, by this configuration, it is possible to easily generate musical pieces with varying difficulty levels.

In the musical piece generation device according to one aspect described above, the value of the difficulty level parameter can be configured to indicate the width of a performance sound range of the new musical piece after the difficulty level is changed. By this configuration, it is possible to specify the difficulty level by the width of the performance sound range. It is thus possible to easily generate musical pieces with various performance sound range widths.

In the musical piece generation device according to one aspect described above, the value of the difficulty level parameter can be configured to indicate a maximum number of simultaneously operated operators in a musical instrument used for the new musical piece after the difficulty level has been changed. By this configuration, it is possible to specify the difficulty level by the maximum number of simultaneously operated operators. It is thus possible to easily generate musical pieces with various maximum numbers of operators.

In the musical piece generation device according to one aspect described above, the target musical piece data can be constituted by an input token sequence arranged to indicate at least a part of the musical piece, and the new musical piece data can be constituted by an output token sequence that is output from the trained generative model and arranged to indicate at least a part of the new musical piece. By this configuration, it is possible to accurately generate musical pieces with various difficulty levels, using a machine learning model (for example, a Transformer, described further below) configured to be capable of handling token sequences.

Embodiments of this disclosure are not limited to a musical piece generation device configured to use a trained generative model to generate a new musical piece. One aspect of this disclosure can be a model generation device that is configured to generate, by machine learning, a trained generative model used in any of the embodiments described above.

For example, a model generation device according to one aspect of this disclosure comprises a training data acquisition module configured to acquire a plurality of training datasets, each formed by a combination of training data and correct answer data, wherein the training data include training musical piece data indicating at least a part of a musical piece and a difficulty level parameter for training, and the correct answer data include new training musical piece data indicating at least a part of a new musical piece generated by changing a difficulty level of the musical piece of the training musical piece data to a difficulty level specified by the difficulty level parameter; and a training processing module configured to, by using the acquired plurality of training datasets, execute machine learning of a generative model, wherein the machine learning being configured by training the generative model such that, with respect to each of the training datasets, musical piece data generated by the generative model from the training musical piece data and a value of the difficulty level parameter included in the training data match the training musical piece data included in the correct answer data. By this configuration, it is possible to generate a trained generative model that has acquired the ability to generate musical pieces with various difficulty levels based on the difficulty level parameter.

In the model generation device according to one aspect described above, the value of the difficulty level parameter included in the training data can be configured to indicate the width of a performance sound range of the new musical piece after the difficulty level is changed. By this configuration, it is possible to generate a trained generative model that has acquired the ability to generate musical pieces of various performance sound range widths.

In the model generation device according to one aspect described above, the value of the difficulty level parameter included in the training data can be configured to indicate a maximum number of simultaneously operated operators in a musical instrument used for the new musical piece after the difficulty level is changed. By this configuration, it is possible to generate a trained generative model that has acquired the ability to generate musical pieces with a varying maximum number of operators.

As another embodiment of the musical piece generation device and the model generation device according to the above-described embodiments, one aspect of this disclosure can be an information processing method that realizes some or all of the configurations described above, an information processing system; a program; or a storage medium that can be read by a computer, or other devices, machines, etc., storing such a program. Here, a computer-readable storage medium accumulates information, such as programs, by electric, magnetic, optical, mechanical, or chemical actions.

For example, a musical piece generation method according to one aspect of this disclosure is an information processing method in which a computer executes a step for acquiring target musical piece data indicating at least a part of a musical piece; a step for acquiring a value of a difficulty level parameter; a step for using a trained generative model to generate, from the acquired target musical piece data and a value of the difficulty level parameter, new musical piece data indicating at least part of a new musical piece obtained by changing the difficulty level of the musical piece to the difficulty level specified by the difficulty level parameter; and a step for outputting the generated new musical piece data.

Further, for example, a musical piece generation program according to one aspect of this disclosure causes a computer to execute a step for acquiring target musical piece data indicating at least a part of a musical piece, a step for acquiring a value of a difficulty level parameter; a step for, by using a trained generative model, generating, from the acquired target musical piece data and the value of the difficulty level parameter, new musical piece data indicating at least a part of a new musical piece obtained by changing the difficulty level of the musical piece to the difficulty level specified by the difficulty level parameter; and a step for outputting the generated new musical piece data.

Further, for example, a model generation method according to one aspect of this disclosure is an information processing method wherein a computer executes a step for acquiring a plurality of training datasets, each formed by a combination of training data and correct answer data, wherein the training data include training musical piece data indicating at least a part of a musical piece and a difficulty level parameter for training, and the correct answer data include new training musical piece data indicating at least a part of a new musical piece generated by changing the difficulty level of the musical piece of the training musical piece data to the difficulty level specified by the difficulty level parameter; and a step for, by using the acquired plurality of training datasets, executing machine learning of a generative model, wherein the machine learning being configured by training the generative model such that, with respect to each of the training datasets, musical piece data generated by the generative model from the training musical piece data and a value of the difficulty level parameter included in the training data match the training musical piece data included in the correct answer data.

Further, a model generation program according to one aspect of this disclosure is a program for causing a computer to execute a step for acquiring a plurality of training datasets, each formed by a combination of training data and correct answer data, wherein the training data include training musical piece data indicating at least a part of a musical piece and a difficulty level parameter for training, and the correct answer data include new training musical piece data indicating at least a part of a new musical piece generated by changing the difficulty level of the musical piece of the training musical piece data to the difficulty level specified by the difficulty level parameter; and a step for, by using the acquired plurality of training datasets, executing machine learning of a generative model, wherein the machine learning being configured by training the generative model such that, with respect to each of the training datasets, musical piece data generated by the generative model from the training musical piece data and a value of the difficulty level parameter included in the training data match the training musical piece data included in the correct answer data.

By this disclosure, it is possible to provide a technology that can easily generate musical pieces with various difficulty levels.

What is claimed is:

1. A musical piece generation device comprising:
an electronic controller including at least one processor,
the electronic controller being configured to execute a plurality of modules including
a data acquisition module configured to acquire target musical piece data indicating at least a part of a musical piece,
a parameter acquisition module configured to acquire a value of a difficulty level parameter,
a generation module configured to, by using a trained generative model, generate, from the target musical piece data and the value of the difficulty level parameter, new musical piece data indicating at least a part of a new musical piece obtained by changing a difficulty level of the musical piece to a difficulty level specified by the difficulty level parameter, and
an output module configured to output the new musical piece data that has been generated.

2. The musical piece generation device according to claim 1, wherein
the value of the difficulty level parameter indicates a width of a performance sound range of the new musical piece after the difficulty level of the musical piece is changed.

3. The musical piece generation device according to claim 1, wherein
the value of the difficulty level parameter indicates a maximum number of simultaneously operated operators in a musical instrument used for the new musical piece after the difficulty level of the musical piece is changed.

4. The musical piece generation device according to claim 1, wherein
the target musical piece data include an input token sequence arranged to indicate at least the part of the musical piece, and
the new musical piece data include an output token sequence that is output from the trained generative model and arranged to indicate at least the part of the new musical piece.

5. A musical piece generation method executed by a computer, the method comprising:
acquiring target musical piece data indicating at least a part of a musical piece;
acquiring a value of a difficulty level parameter;
generating, by using a trained generative model, from the target musical piece data and the value of difficulty level parameter, new musical piece data indicating at least a part of a new musical piece obtained by changing a difficulty level of the musical piece to a difficulty level specified by the difficulty level parameter; and
outputting the new musical piece data that has been generated.

6. The musical piece generation method according to claim 5, wherein
the value of the difficulty level parameter indicates a width of a performance sound range of the new musical piece after the difficulty level of the musical piece is changed.

7. The musical piece generation method according to claim 5, wherein
the value of the difficulty level parameter indicates a maximum number of simultaneously operated operators in a musical instrument used for the new musical piece after the difficulty level of the musical piece is changed.

8. The musical piece generation method according to claim 5, wherein
the target musical piece data include an input token sequence arranged to indicate at least the part of the musical piece, and
the new musical piece data include an output token sequence that is output from the trained generative model and arranged to indicate at least the part of the new musical piece.

9. A model generation method executed by a computer, the method comprising:
acquiring a plurality of training datasets each of which includes a combination of training data and correct answer data, the training data including training musical piece data that indicate at least a part of a musical piece and including a difficulty level parameter for training, the correct answer data including new training musical piece data indicating at least a part of a new musical piece generated by changing a difficulty level of the musical piece of the training musical piece data to a difficulty level specified by the difficulty level parameter; and
executing machine learning of a generative model by using the plurality of training datasets that have been acquired, the machine learning being configured by training the generative model such that, with respect to each of the training datasets, musical piece data, which are generated by the generative model from the training musical piece data and a value of the difficulty level parameter that are included in the training data, match the new training musical piece data included in the correct answer data.

10. The model generation method according to claim 9, wherein
the value of the difficulty level parameter included in the training data indicates a width of a performance sound range of the new musical piece after the difficulty level of the musical piece is changed.

11. The model generation method according to claim 9, wherein
the value of difficulty level parameter included in the training data indicates a maximum number of simultaneously operated operators in a musical instrument used for the new musical piece after the difficulty level of the musical piece is changed.
